(19) United States
(12) Patent Application Publication
(10) Pub. No.: US 2023/0295404 A1
(43) Pub. Date: Sep. 21, 2023

(54) POLYOLEFIN COMPOSITIONS, MOULDED BODIES CONTAINING SAME AND USE THEREOF

(71) Applicant: Topas Advanced Polymers GmbH, Raunheim (DE)

(72) Inventor: Wolfram Goerlitz, Wiesbaden (DE)

(21) Appl. No.: 18/020,224

(22) PCT Filed: Aug. 10, 2021
(86) PCT No.: PCT/EP2021/000095

§ 371 Date: Feb. 7, 2023

(30) Foreign Application Priority Data
Aug. 26, 2020 (DE) 20 2020 003 627.7

(51) Int. Cl. C08L 23/12; C08J 5/18

(52) U.S. Cl. CPC C08L 23/12; C08J 5/18; C08J 2323/12; C08J 2445/00; H01G 4/18

(57) ABSTRACT

A polyolefin composition is described which comprises poly-(alpha-olefin) and 10 to 45% by weight, based on the total weight of the composition, of cycloolefin polymer having a glass transition temperature of at least 30° C. This polyolefin composition has domains of cycloolefin polymer in a matrix of poly-(alpha-olefin) in the form of plates.

These polyolefin compositions and the moulded articles made therefrom exhibit excellent barrier properties to gases and vapors and excellent dielectric properties.

### CLAIM FOR PRIORITY

This application is a national phase application of PCT/EP2021/000095 having an international filing date of 10 Aug. 2021, which was based on application DE 20 2020 003 627.7, filed 26 Aug. 2020. The priorities of PCT/EP2021/000095 and DE 20 2020 003 627.7 are hereby claimed and their disclosures incorporated by reference herein.

### TECHNICAL FIELD

The present invention relates to polyolefin compositions and moulded articles made therefrom, in particular films.

### BACKGROUND

The polyolefin compositions contain cycloolefin polymer domains of selected shape in a polyolefin matrix. These moulded articles can be used in a wide variety of fields, for example as packaging films, in the medical field or as electrical insulators in the electrical and electronics field, in particular as dielectrics in capacitors.

Biaxially oriented PP films (BOPP films) for use as dielectric in capacitors are described in several patent documents, for example in WO 2015/091829 A1, U.S. Pat. No. 5,724,222 A and EP 2 481 767 A2. Biaxially oriented polyolefin films containing cycloolefin polymers are known from WO 2018/197034 A1.

BOPP films as well as biaxially oriented polyolefin films containing cycloolefin polymers have excellent electrical and mechanical properties. The latter are characterized by increased resistance at temperatures above 100° C. and low thermal shrinkage.

Furthermore, films made from blends of cycloolefin polymers and PP are known. JP H05-262,898 A discloses biaxially oriented films consisting of a blend of 40-98 wt % of crystalline polyolefin and 2-60 wt % of copolymer derived from ethylene and a cyclic olefin. These films are used as packaging material.

DE 10 2010 034 643 A1 discloses compositions comprising at least one cycloolefin polymer having a glass transition temperature of at least 140° C., at least one polymer derived from alpha-olefin(s) and at least one selected copolymer as a component improving the compatibility of these components.

Polyolefin films comprising polyolefin and cycloolefin polymer are known from DE 195 36 043 A1, wherein the cycloolefin polymer is amorphous, has an average molecular weight M_{w} in the range of 200 to 100000, which is at most 50% of the M_{w} of the polyolefin, and the cycloolefin polymer is a homopolymer or has at most 20% by weight of comonomer content. The compositions are suitable for the production of packaging films.

From WO 2018/197034 A1, polyolefin films are known which can preferably be used as capacitor films and which are characterized by an increased resistance of the electrical properties and by a low shrinkage at elevated temperatures.

It is known that in polyolefin blends the cycloolefin polymer is generally dispersed in a matrix of the polyolefin. Surprisingly, when investigating such polyolefin mouldings having the same composition, it was found that the shape of the domains has a significant influence on the properties of the mouldings. For example, the gas and vapor permeability, such as the permeability to oxygen, nitrogen or water vapor, or electrical properties, such as insulation properties, dielectric strength or service life of such mouldings can be influenced by the domain shape.

As explained above, polyolefin/cycloolefin polymer blends are sufficiently well known from the literature. However, an essential feature of such material blends, the blend morphology, which is decisive for the properties in addition to the material composition, is hardly mentioned in the literature. This is probably due, among other things, to the fact that the phase distribution for blends of similar polymers is not easily accessible by measurement, and is difficult to interpret. This is especially true for thin oriented films, where the dimensions of the embedded phases can become very thin due to the stretching process.

During the manufacture of films and products made from them, e.g. barrier films or film capacitors, scattering of film properties, for example barrier properties or dielectric properties, is often observed. The morphology of the polymer blends has been suspected as one reason for this. Criteria for identifying the morphology of products with particular suitability as barrier or capacitor films are not yet known.

Thus, there is a need for an easy-to-implement method to represent the morphology of polyolefin compositions and to interpret it in terms of expected properties.

### SUMMARY OF THE INVENTION

The present invention is directed to polyolefin compositions comprising poly-(alpha-olefin) and 10 to 45% by weight based on the total weight of the composition, of cycloolefin polymer having a glass transition teperature of at least 30° C. This polyolefin composition has domains of cycloolefin polymer in a matrix of poly-(alpha-olefin) in the form of plates.

Surprisingly, it was found that already the evaluation of the morphology of undrawn or of drawn polyolefin compositions by means of statistical quantities, in particular the aspect ratio of the domains, allows predications about favorable properties.

One objective of the present invention is to provide polyolefin compositions and moulded articles made therefrom that have an excellent barrier effect against gases and vapors, such as water vapor.

Another objective of the present invention is to provide polyolefin compositions and moulded articles made therefrom which have excellent insulator properties and a low dielectric loss factor, and which can be readily processed into capacitors.

Still another objective of the present invention is to provide polyolefin compositions and moulded articles made therefrom which have very good mechanical properties such as low shrinkage, especially at elevated temperatures.

### DESCRIPTION OF THE DRAWINGS

FIG. 1a is a schematic illustrating an unstretched polyolefin film not according to the invention.

FIG. 1b illustrates a cross section transverse to the machine direction showing the filamentary COC domains.

FIG. 1c illustrates an ellipsoidal cross section of the filamentous COC domains.

FIGS. 2a and 2b illustrate scanning electron micrographs of an undrawn polyolefin film of polypropylene and COC according to the invention.

FIG. 3 is a schematic of a frequency distribution of the quotient of lengths to thickness of plate-like domains in the machine direction from scanning electron micrographs of undrawn polyolefin films of polypropylene and COC.

FIG. 3 curve 1 shows a film not according to the invention.

FIG. 3, curve 2 shows a film according to the invention with an increased proportion of plate-like domains.

FIG. 3 curve 3 shows a film according to the invention with a high proportion of plate-like domains.

FIGS. 4a, 4b, 4c show scanning electron micrographs of unstretched polyolefin films of polypropylene and COC.

### DETAILED DESCRIPTION OF THE INVENTION

The present invention relates to a polyolefin composition comprising poly-(alpha-olefin) and 10 bis 45% by weight, referring to the total mass of the composition, of cycloolefin polymer having a glass transition temperature of at least 30° C., wherein the cycloolefin polymer forms domains in a matrix of poly-(alpha-olefin), which are shaped as plates, preferably as disks or as ellipsoids.

In the context of this description, plates are flat structures that have significantly larger dimensions in two dimensions than in the third dimension perpendicular to them. The shape of the plates, viewed from the third dimension, can be arbitrary. Preferably, they are rectangles, parallelograms, diamonds or squares, and in particular circles or ellipses. The plates are especially preferably in the form of a cylinder compressed in the third dimension or an elliptical cylinder, or as an ellipsoid.

As a rule, the two dimensions with the larger dimensions run in a plane of the composition or moulded article, for example in the film plane, while the third dimension with the small dimension runs in the direction of the cross-section of the moulded article, such as the film cross-section. This means that the plate-shaped cycloolefin polymer domains align parallel to the plane of the composition or the moulded body. In this case, the amount of cycloolefin polymer relative to the amount of poly-(alpha-olefin) should be selected so that the domains do not form large-area plates, but rather that the individual plates are isolated from one another or are only partially in contact. Typically, several superimposed or laterally staggered plates are formed in the composition or moulded article, aligned in the plane of the composition or moulded article. If the composition or moulded body is viewed from the top or bottom thereof, the superimposed and preferably staggered plates cover a large portion of the area of the composition or moulded body and preferably overlap a plurality of times. Paths running in the direction of the cross-section in the poly-(alpha-olefin) are thus considerably lengthened, and preferably there are no longer any direct straight paths running in the poly-(alpha.olefin) through the cross-section.

The shape of the cycloolefin polymer domains can be determined on polyolefin compositions or polyolefin mouldings according to the invention by cutting out thin sections in a predetermined direction. The cycloolefin polymer is then removed by treatment with a solvent that is not a solvent for the polyolefin matrix. The section thus prepared can be examined, for example, in a scanning electron microscope for the presence of cavities and for their shape. Aliphatic or cycloaliphatic hydrocarbons, for example, can be used as solvents for preparing the films, in particular cyclohexane.

The invention also relates to a process for the determination of the shape of cycloolefin polymer domains in a polyolefin matrix encompassing the measures:
i) producing of a moulded article, preferably a film, from a polyolefin composition comprising poly-(alpha-olefin) and 10 bis 45% by weight, referring of the total mass of the composition, of cycloolefin polymer having a glass transition temperature of at least 30° C.,
ii) cutting of sections from the moulded article in a predetermined direction,
iii) treatment of the sections with a solvent, which is not a solvent for the polyolefin matrix ist, to remove the cycloolefin polymer from the sections, and
iv) investigation of the sections so prepared with a microscope on the presence of cavities and on the shape thereof.

If the cut to create the sections is made perpendicular to the thickness of the composition or moulded body and parallel to the machine direction of the composition or moulded body, the length of the domains in the machine direction and the thickness of the domains in the thickness direction will be recognized from the scanning electron microscope image.

If the cut to create the sections is made perpendicular to the thickness of the composition or moulded body and perpendicular to the machine direction of the composition or moulded body, the length of the domains across the machine direction and the thickness of the domains in the thickness direction will be recognized from the scanning electron microscope image.

In the case that the domains have not formed the shape of plates but the shape of fibers running in a preferred direction, one will recognize significantly greater domain lengths in the sections in this preferred direction than across it. This domain shape is not desired according to the invention and is present only to a small extent, if present at all, in the polyolefin composition according to the invention.

In the case where the domains have formed the shape of plates extending in one direction and transversely thereto, similar domain lengths will be recognized in the sections in this direction than transversely thereto. This domain shape is desired according to the invention and is present to a predominant extent in the polyolefin composition according to the invention.

The plate-shaped domains can be characterized by the ratio of their lengths in the plane of the composition or moulded body and perpendicular to it. The ratio of the domain length in the plane of the plate to its smallest lateral extent, i.e. to the domain thickness, is called the aspect ratio.

It was found that a high proportion of spherical domains or of filamentous domains of cycloolefin polymer in the poly(alpha-olefin) matrix are unfavorable for the use of the polyolefin compositions or of the moulded articles made from them. The compositions according to the invention have no or only a small amount of spherical or filamentous domains. A significant portion of the COC in the poly-(alpha-olefin) matrix is in the form of plates. Typically, at least 30 wt % of the total amount of COC in the compositions of the invention is in the form of plates, or in other words, less than 70 wt % of the total amount of COC is in domains with an aspect ratio of less than 4.

The aspect ratio of the domains is determined as the quotient of the length in any direction in the face of the domain to the length in the direction of the thickness of the domain. According to the invention, the polyolefin compositions contain plates with an aspect ratio of at least 4. This aspect ratio means that the quotients of the length in any direction in the face of the domain to the length in the direction of the thickness of the domain are at least 4.

Spherical domains do not show high aspect ratios in any cutting direction. Filamentary domains show high aspect ratios only when cut parallel to the filament. Planar domains, on the other hand, as they occur to a considerable extent in the compositions according to the invention, show high aspect ratios in any cutting direction perpendicular to the domain thickness.

The compositions according to the invention have substantial proportions of COC domains with aspect ratios above 4 both when cut in the direction of flow of the polymer melt during the production of the compositions or the moulded articles made therefrom and transversely thereto. The planar domains arrange themselves in the composition according to the invention such that the planes of the sheets align in the direction of flow of the melt and transversely thereto.

Compositions according to the invention may be characterized by the fact that scanning electron microscope (SEM) images of sections along and across the flow direction of the melt show large proportions of domains with high aspect ratio.

In the case of non-oriented compositions, such as films, the plate-like domains typically have dimensions perpendicular to the thickness of the composition, for example in the film plane, of from 0.5 to 50 μm, preferably from 0.75 to 20 μm and in particular from 1 to 10 μm. Here, the dimensions in the direction of flow of the melt are generally somewhat larger than transversely thereto, for example from 0.1 to 20 μm in the direction of flow of the melt and 0.1 to 5 μm transversely to the direction of flow of the melt. In non-oriented compositions or mouldings made therefrom, the plate-like domains typically have dimensions in the direction of the thickness of the composition of from 0.05 to 5 μm, preferably from 0.1 to 2 μm, and especially from 0.1 to 1 μm. After drawing, the dimensions of the domains perpendicular to the drawing direction have decreased accordingly and are typically at dimensions of less than 1 μm, with the ratio of longitudinal to transverse direction being substantially maintained during uniform biaxial drawing.

For the purposes of this description, non-oriented compositions are understood to be compositions which have been formed directly from the polymer melt after shaping and have then cooled.

Drawn compositions within the meaning of this description are compositions which have not been formed directly from the polymer melt, but have been drawn in a second processing step from a non-oriented composition, e.g. from a semi-finished product or a pre-film which has been brought into a formable state by reheating.

The size of the domains in the compositions, whether in the form of plates or of fibers or of other shapes, is subject to distribution, i.e. the individual domains are of different sizes. The shape and size of the domains can be determined by electronic image analysis of the scanning electron microscopic images described above. From this, distributions of the length ratios of individual domains in a certain direction can be determined. This procedure is known to the person skilled in the art.

Preferred compositions, in particular in the form of films, contain COC domains with an aspect ratio of at least 4, the area ratio of these domains to the total area of the domains being at least 30%.

Generally, the domains of the polyolefin composition according to the invention in the undrawn state have a quotient of the length in the flow direction of the melt to the length in the direction of the domain thickness of 1 to 25, wherein the area fraction of the domains with a quotient of the length in the flow direction of the melt to the length in the direction of the domain thickness between 1 and up to less than 4 is less than 70%, preferably less than 60% and more preferably less than 50% of the total area of the domains, and preferably the area fraction of the domains with a quotient of the length in the flow direction of the melt to the length in the direction of the domain thickness between 4 and 25 being more than 30%, preferably more than 40% and more preferably more than 50% of the total area of the domains.

Generally, the domains of the polyolefin composition according to the invention in the undrawn state have a quotient of the length transverse to the direction of flow of the melt to the length in the direction of the domain thickness of 1 to 25, wherein the area fraction of the domains with a quotient of the length transverse to the direction of flow of the melt to the length in the direction of the domain thickness between 1 and 4 is less than 60%, preferably less than 50% and more preferably less than 40% of the total area of the domains, and wherein preferably the area fraction of the domains with a quotient of the length transverse to the flow direction of the melt to the length in the direction of the domain thickness between 4 and 25 is more than 40%, preferably more than 50% and more preferably more than 60% of the total area of the domains.

The cycloolefin polymers used according to the invention are polymers known per se. They may be polymers derived from one monomer or from two or more different monomers.

The cycloolefin polymers are prepared by ring-opening or, in particular, ring-maintaining polymerization, preferably by ring-maintaining copolymerization of cyclic olefins, such as norbornene, with non-cyclic olefins, such as alpha-olefins, in particular ethylene.

The choice of catalysts can be used to control, in a manner known per se, whether the olefinic ring of the cyclic monomer is retained or opened during polymerization. Examples of ring-opening polymerization processes for cycloolefins can be found in EP 0 827 975 A2. Examples of catalysts mainly used in ring-retaining polymerization are metallocene catalysts. An overview of possible chemical structures of polymers derived from cycloolefins can be found, for example, in Pure Appl. Chem. vol. 77, no. 5, pp. 801-814 (2005).

In the context of this description, the term “cycloolefin polymer” also refers to polymers which have been subjected to hydrogenation after polymerization in order to reduce any double bonds still present.

The cycloolefin polymers used according to the invention are thermoplastics which are characterized by an extraordinarily high transparency.

The glass transition temperature (hereinafter also referred to as “Tg”) of cycloolefin polymers can be adjusted by the skilled person in a manner known per se by selecting the type and amount of monomers, e.g. the type and amount of cyclic and non-cyclic monomers. For example, it is known from norbornene-ethylene copolymers that the higher the proportion of norbornene component in the copolymer, the higher the glass transition temperature. The same applies to combinations of other cyclic monomers with non-cyclic monomers.

In the context of the present description, glass transition temperature means the temperature determined according to ISO 11357 by the differential scanning calorimetry (DSC) method, the heating rate being 10 K/minute.

Cycloolefin polymers with glass transition temperatures greater than 30° C. can be used in the polymer films according to the invention. Preferably, the glass transition temperatures are 80 to 250° C., more preferably 100 to 170° C., most preferably 130 to 170° C. and very most preferably 140 to 160° C.

In a further preferred embodiment of the polyolefin moulded article according to the invention, cycloolefin copolymers derived from the ring-retaining copolymerization of at least one cycloolefin of the general formula (I) with at least one alpha-olefin of the formula (II) are used

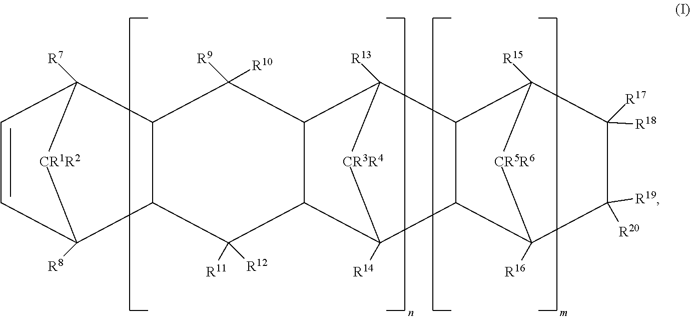

wherein
n is 0 or 1,
m is 0 or a positive integer, preferably 0 or 1,
R¹, R², R³, R⁴, R⁵, R⁶ independently of one another are hydrogen, halogen, alkyl groups, cycloalkyl groups, aryl groups and alkoxy groups,
R⁷, R⁸, R⁹, R¹⁰, R¹¹, R¹², R¹³, R¹⁴, R¹⁵, R¹⁶ independently of one another are hydrogen and alkyl groups,
R¹⁷, R¹⁸, R¹⁹, R²⁰ independently of one another are hydrogen, halogen and alkyl groups,
wherein R¹⁷ and R¹⁹ can be connected with one another, such that these form a single ring or a ring system with several rings, wherein the ring or the rings may be saturated or unsaturated.

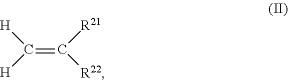

wherein R²¹ and R²² independently of one another are hydrogen and alkyl groups.

In a particularly preferred embodiment, cycloolefin copolymers are used which are derived from compounds of the formulae I and II in which n is 0, m is 0 or 1, R²¹ and R²² are both hydrogen or R²¹ is hydrogen and R²² is an alkyl group having from one to eight carbon atoms, and R¹, R², R⁵ to R⁸ and R¹⁵ to R²⁰ are preferably hydrogen.

In a very particularly preferred embodiment, cycloolefin copolymers are used which are derived from compounds of the formulae I and II in which the compound of the formula I is norbornene or tetracyclododecene and the compound of the formula II is ethylene.

Very preferably, copolymers of the type defined above are used, the copolymerization of which has been carried out in the presence of a metallocene catalyst.

Preferred grades of cycloolefin copolymers are described in DE 102 42 730 A1. Particularly preferred cycloolefin copolymers are Topas® 6013, Topas® 6015 and Topas® 5013 (Topas Advanced Polymers GmbH, Raunheim).

The cycloolefin copolymers preferred according to the invention are prepared under ring-preserving polymerization, i.e. the bi- or polycyclic structure of the monomer units used is retained during polymerization. Examples of catalysts are titanocene, zirconocene or hafnocene catalysts, which are usually used in combination with aluminoxanes as co-catalysts. This production method has already been described many times, for example in the patent document mentioned above.

Typical examples of cycloolefin copolymers are copolymers of norbornene or tretracyclododecene with ethylene. Such polymers are commercially available, for example under the trade names APEL®, ARTON® or TOPAS®.

Further examples are cycloolefin polymers derived from ring-opening polymerization or copolymerization of cyclic olefins, for example cyclopentadiene, norbornene or their substituted derivatives. Such polymers are also commercially available, for example under the trade names ZEONEX® or ZEONOR®.

Cycloolefin copolymers are preferably used which are derived from the monomers of the formulae I and II described above, these monomers I:II having been used in a molar ratio of 95:5 to 5:95 and which optionally still contain small proportions of structural units, for example up to 10 mol %, based on the total monomer quantity, which are derived from further monomers, such as propylene, pentene, hexene, cyclohexene and/or styrene.

Particularly preferred are cycloolefin copolymers consisting essentially of norbornene and ethylene and optionally containing small amounts, for example up to 5% by weight, based on the total monomer amount, of structural units derived from further monomers such as propylene, pentene, hexene, cyclohexene and/or styrene.

Other particularly preferred cycloolefin polymers have a melt flow index between 0.3-12 g/10 minutes, measured at a temperature of 230° C. under a load of 2.16 kg.

As matrix component, the composition according to the invention contains one or more poly-(alpha-olefins). These are essentially ethylene homo- or copolymers or propylene homo- or copolymers. They may be semicrystalline ethylene homopolymers, preferably having a crystallite melting temperature of 130 to 140° C., or semicrystalline ethylene-C₃-C₈-alpha-olefin copolymers, preferably having a crystallite melting temperature of 50 to 130° C., or are semicrystalline propylene homopolymers which preferably have a crystallite melting temperature of 160 to 165° C. and/or are semicrystalline propylene-C₄-C₈-alpha-olefin copolymers which preferably have a crystallite melting temperature of 100 to 160° C.

Examples of C₃-C₈ alpha-olefins are propylene, butene-1, hexene-1, octene-1.

The polyolefins of the matrix component are linear or branched types. The sequence of different monomer units in these polyolefins can be random or in the form of blocks. The individual monomer units may be sterically arranged in different ways, for example, isotactically, syndiotactically or atactically.

Preferred poly-(alpha-olefins) are polyolefin homopolymers derived from ethylene or propylene or polyolefin copolymers derived from ethylene and/or propylene containing up to 10% by weight of higher alpha-olefins with 4-8 C atoms. Copolymers in this context also include polymers derived from three or more different monomers.

Poly-(alpha-olefins) used very preferably are high-density polyethylene (HDPE), medium-density polyethylene (MDPE) and low-density polyethylene (LDPE). These polyethylenes are produced by the low-pressure or high-pressure process with appropriate catalysts and are characterized by low density compared with other plastics (<0.96 g/cm³), by high toughness and elongation at break, by very good electrical and dielectric properties, by very good chemical resistance, and, depending on the type, by high resistance to stress cracking and good processability.

The polyethylene molecules contain branches. The degree of branching of the molecular chains and the length of the side chains significantly influence the properties of the polyethylene. The HDPE and MDPE grades have little branching and only short side chains.

Polyethylene crystallizes from the melt during cooling. In the process, the long molecular chains arrange themselves in folded sections and form very small crystallites, which are joined together with amorphous zones to form superstructures known as spherulites. The shorter the chains and the lower the degree of branching, the better the crystallization. The crystalline portion has a higher density than the amorphous portion. Therefore, different densities are obtained, depending on the crystalline portion. This degree of crystallization is between 35% and 80%, depending on the type of polyethylene.

For high-density polyethylene (HDPE), 60% to 80% degree of crystallization is achieved at densities between 0.940 g/cm³ and 0.97 g/cm³. For medium density polyethylene (MDPE), 50% to 60% degree of crystallization is achieved at densities between 0.930 g/cm³ and 0.940 g/cm³. Low density polyethylene (LDPE) achieves 40% to 50% degree of crystallization at densities between 0.915 g/cm³ and 0.935 g/cm³. This type involves highly branched polymer chains, which result in a low density.

In addition, linear low-density polyethylene (LLDPE) is also known. Its polymer molecule has only short branches. These branches are produced by copolymerization of ethylene and higher α-olefins, such as butene, hexene or octene. The degree of crystallization of this type is 10 to 50% and the density is in the range of 0.87 g/cm³ to 0.940 g/cm³.

The properties of polyethylene are mainly determined by density, molar mass and molar mass distribution. For example, impact strength, notched impact strength, tensile strength, elongation at break and resistance to stress cracking increase with molar mass. Narrowly distributed HDPE with low low molecular weight content is more impact resistant, even at low temperature, than broadly distributed within the same ranges for melt index and viscosity number. Broadly distributed grades, in turn, are easier to process.

Polypropylene is an isotactic, syndiotactic or atactic polypropylene produced with the aid of stereospecifically acting catalysts. Particularly preferred is the isotactic polypropylene, in which all methyl groups are arranged on one side of the imaginary zigzag molecular chain, in the compositions according to the invention.

When cooling from the melt, the regular structure of the isotactic polypropylene favors the formation of crystalline regions. However, the chain molecules are rarely incorporated into a crystallite in their entire length, since they also contain non-isotactic and thus non-crystallizable portions. In addition, amorphous regions are formed by the entanglement of the chains in the melt, especially at high degrees of polymerization. The crystalline content depends on the manufacturing conditions of the compositions or the moulded parts made from them and is 50% to 70%. The semi-crystalline structure gives some strength and stiffness because of the high secondary forces in the crystallite; while the disordered regions with the higher mobility of their chain segments above the freezing temperature give flexibility and toughness.

The density of polypropylene is very low and is between 0.895 g/cm³ and 0.92 g/cm³. Moulded articles made of polypropylene are characterized by higher stiffness, hardness and strength compared with moulded articles made of polyethylenes. Polypropylene has a glass transition temperature of 0 to −10° C. The crystallite melting range is 160 to 165° C. These temperatures can be modified by copolymerization; the measures for this are known to the skilled person.

Preferred matrix components of the compositions according to the invention are HDPE, MDPE, LDPE, LLDPE, HMWPE, UHMWPE, propylene homopolymers, propylene copolymers with 1-10 wt % of structural units derived from 1-alkenes with 4-8 C atoms, propylene ethylene copolymers with 10-90 wt % of structural units derived from propylene, and combinations of two or more thereof.

The preferred matrix component in the polyolefin compositions according to the invention is a semi-crystalline alpha-olefin polymer having a crystallite melting temperature between 150 and 170° C.

Particularly preferred are semi-crystalline propylene homopolymers which preferably have a crystallite melting temperature of 160 to 165° C. or semi-crystalline propylene C₄-C₈ alpha-olefin copolymers which preferably have a crystallite melting temperature of 150 to 160° C.

In the context of the present description, crystallite melting temperature means the temperature determined according to ISO 11357 by the differential scanning calorimetry (DSC) method, the heating rate being 20 K/minute.

Examples of C₄-C₈ alpha-olefins are butene-1, hexene-1, octene-1.

The selected semi-crystalline polyolefins for the preparation of the polyolefin composition according to the invention are linear or branched types. The sequence of different monomer units in these polyolefins may be random or in the form of blocks. The individual monomer units may be sterically arranged in different ways, for example, isotactically, syndiotactically or atactically.

Preferred semi-crystalline polyolefins used are polyolefin homopolymers derived from propylene or polyolefin copolymers derived from propylene with a content of up to 10% by weight of higher alpha-olefins with 4-8 C atoms. Copolymers in this context also include polymers derived from three or more different monomers.

Polypropylene is an isotactic, syndiotactic or atactic polypropylene produced with the aid of stereospecific catalysts.

Polypropylene crystallizes from the melt during cooling. In the process, the long molecular chains arrange themselves in folded sections and form very small crystallites, which together with amorphous zones can be connected to form superstructures known as spherulites. The shorter the chains and the lower the degree of branching, the better the crystallization. The crystalline portion has a higher density than the amorphous portion. Therefore, different densities are obtained, depending on the crystalline portion. The degree of crystallization in polypropylenes is typically in the range between 35% and 80%, preferably between 60% and 80%.

The density of polypropylene is very low and ranges between 0.895 g/cm³ and 0.92 g/cm³. Polypropylene usually has a glass transition temperature of 0 to −10° C. The crystallite melting range is usually 160 to 165° C. These temperatures can be modified by copolymerization; measures for this are known to the person skilled in the art.

Particularly preferred semi-crystalline alpha-olefin polymers have a melt flow index between 2-5 g/10 minutes, measured at a temperature of 230° C. under a load of 2.16 kg.

Particularly preferably, the polyolefin composition according to the invention has a low metal content. This is desirable for use as a capacitor film, since even traces of metals in the dielectric can adversely affect the electrical properties of the capacitor.

Preferably, the total content of iron, cobalt, nickel, titanium, molybdenum, vanadium, chromium, copper and aluminum in the composition according to the invention is less than 0.25 ppm.

Polyolefin compositions in which the cycloolefin polymer domains form sheets whose thickness is not more than 5% of the thickness of the polyolefin composition or of the moulded article made therefrom are preferred, several of which are arranged one above the other as viewed in the direction of the thickness and offset from one another perpendicularly thereto.

Preferred are undrawn polyolefin compositions in which the domains have a ratio of the length in the direction of flow of the melt to the length in the direction of domain thickness of from 1 to 25, wherein the area fraction of the domains having a ratio of the length in the direction of flow of the melt to the length in the direction of domain thickness of between 1 and less than 4 is less than 50% of the total area of the domains, and wherein the area fraction of the domains having a quotient of the length in the flow direction of the melt to the length in the domain thickness direction between 4 and 25 is more than 50% of the total area of the domains. In addition, polyolefin mouldings produced from these undrawn polyolefin compositions or from the mouldings produced therefrom by biaxial stretching, in particular biaxially stretched films, are preferred.

Also preferred are undrawn polyolefin compositions in which the domains have a ratio of the length transverse to the direction of flow of the melt and perpendicular to the domain thickness to the length in the direction of the domain thickness of from 1 to 25, wherein the area fraction of the domains having a ratio of the length transverse to the direction of flow of the melt and perpendicular to the domain thickness—to the length in the direction of the domain thickness of between 1 and less than 4 is less than 40% of the total area of the domains, and wherein the area fraction of the domains having a quotient of the length transverse to the flow direction of the melt and perpendicular to the domain thickness—to the length in the direction of the domain thickness between 4 and 25 is more than 60% of the total area of the domains. Moreover, the polyolefin mouldings produced from these undrawn polyolefin compositions or from the mouldings produced therefrom by biaxial stretching, in particular biaxially stretched films, are preferred.

Also preferred are polyolefin compositions in which the poly(alpha-olefin) is an ethylene homopolymer, an ethylene copolymer with other alpha-olefins, a propylene homopolymer or a propylene copolymer with other alpha-olefins.

Particularly preferred are polyolefin mouldings which have the form of a film, in particular that of a biaxially stretched film.

Particularly preferred are polyolefin compositions in which the poly-(alpha-olefin) is a semi-crystalline polypropylene with a crystallite melting temperature between 150 and 170° C.

Also particularly preferred are polyolefin compositions in which the cycloolefin polymer has a glass transition temperature between 100 and 170° C., preferably between 130 and 170° C., and particularly preferred between 140 and 160° C.

Very particularly preferred are polyolefin compositions and the mouldings produced therefrom, in particular films, containing 10 to 45% by weight of a cycloolefin polymer having a glass transition temperature between 100 and 170° C., and 90-55% by weight of a semicrystalline alpha-olefin polymer having a crystallite melting temperature between 100 and 170° C., the glass transition temperature of the cycloolefin polymer being less than or equal to the crystallite melting temperature of the alpha-olefin polymer.

Very particularly preferred are polyolefin compositions and the mouldings produced therefrom, in particular films, in which the cycloolefin polymer is a copolymer prepared by copolymerization of norbornene or tetracyclododecene with ethylene and/or propylene, wherein the copolymerization has preferably taken place in the presence of a metallocene catalyst.

Also very particularly preferred are polyolefin compositions and the mouldings made therefrom, in particular films, in which the poly(alpha-olefin) is a partially crystalline propylene homopolymer or a copolymer obtained by copolymerizing propylene with an amount of less than or equal to 5% by weight of an alpha-olefin having two or having four to eight carbon atoms.

Preferred polyolefin compositions and the mouldings produced therefrom, in particular films, contain no additives besides the poly(alpha-olefin) and the cycloolefin polymer.

In a particularly preferred embodiment, which is preferably used in electrical components, especially as a dielectric in capacitors, the total content of iron, cobalt, nickel, titanium, molybdenum, vanadium, chromium, copper and aluminum in the polyolefin film is less than 0.25 ppm.

Preferably, the polyolefin moulded article according to the invention is a stretched film, in particular a biaxially stretched film.

The thickness of the polyolefin moulded article according to the invention can vary over a wide range. Typical thicknesses are in the range of 0.2 to 5 mm, preferably in the range of 0.5 to 100 μm. In the case of films, the thickness is preferably between 0.5 and 50 μm, in particular between 0.5 and 15 μm, and very preferably between 1 and 10 μm. The thickness of the moulded article is determined according to DIN 53370.

In a further preferred embodiment, the polyolefin moulded article according to the invention, in particular the film, is metallized on one or both sides.

The polymer blends used in the polyolefin compositions according to the invention can basically be produced by mixing the individual components in devices suitable for this purpose. Mixing can advantageously be carried out in kneaders, rolling mills or extruders.

The amount of cycloolefin polymer in the polymer blend is 10 to 45% by weight, based on the total blend, preferably 15 to 40% by weight, in particular 15 to 35% by weight, and particularly preferably 20 to 35% by weight.

The amount of poly(alpha-olefin) in the polymer blend is typically 90 to 55 wt %, based on the total blend, preferably 85 to 60 wt %, and more preferably 80 to 65 wt %.

In addition to the cycloolefin polymer and the poly-(alpha-olefin), which are obligatory, the polymer blend may also contain additives that are customary per se. The total proportion of these additives is usually up to 5% by weight, based on the total blend, preferably up to 2% by weight.

Additives also known as auxiliary materials or as adjuvants are substances which are added to the polymer blend in small quantities in order to achieve or improve certain properties, for example to achieve a positive effect on production, storage, processing or product properties during and after the use phase.

The additives may be processing aids, such as oils or waxes, or additives that impart a specific function to the polymer blend or the polyolefin moulded article according to the invention, such as plasticizers, UV stabilizers, matting agents, preservatives, biocides, antioxidants, antistatics, flame retardants, reinforcing agents, fillers, pigments or dyes.

The polyolefin moulded article according to the erfindings is obtained by heat moulding the polymer blend described above. Different heat moulding processes can be used. For example, the moulding compound can be formed by extrusion from a single-screw or twin-screw extruder using a die, or the moulded article can be produced directly with a given thickness by a blowing or calendering process, or a two-stage process can be carried out in which the moulding compound is heated and melted, thereby obtaining a preformed product therefrom, and wherein the product is heated and stretched and, if necessary, fixed by heat.

The formation of the blend morphology is determined on the one hand by the selection of the polymers, and on the other hand by geometry and process parameters during moulding to form a melt film or moulded part.

On the polymer side, the rheology of the polymer melt plays a role. This is influenced by the ratio of the flow properties of the polymer components, the elasticity of the melt, the relaxation times after deformation of the melt, and by the melting and glass transition temperatures of the semi-crystalline and amorphous phases of the polymers used.

On the process side, melt temperatures and shear and flow rates of the polymer melt play a role, the latter being influenced by the geometry of the melt flow paths. Thus, the die geometry plays an essential role in the production of the melt film.

The production of films and products made from them, e.g. barrier films or film capacitors, showed scattering of product properties.

The methodology shown here makes it possible to identify particularly well-suited morphologies at an early stage of processing—namely on the solidified melt—and thus to identify products with the optimum properties desired in each case.

When producing the composition or the moulded article, conditions must therefore be selected which promote the formation of plate-like domains of cycloolefin polymer and impede the formation of filamentous domains of cycloolefin polymer. Various influencing factors in the production process can play a role here. Examples include the nozzle geometry already mentioned above, the shear rates when the material is ejected from the nozzle, and the material selection.

The nozzles used can be, for example, slot nozzles, T-nozzles or ring nozzles.

Preferably, the polyolefin composition according to the invention is produced by moulding using a slot die, T-nozzle or annular die.

Typical dimensions of nozzle openings for slot and T nozzles are in the range of 0.5 to 5 mm for the nozzle gap, while a range of 20 cm to 8 m is common for the nozzle width. For ring nozzles, the size of the nozzle gap also ranges from 0.5 to 5 mm, and any diameter of the ring nozzles can be used.

After moulding, the resulting preformed and stretchable product is preferably solidified by cooling. The cooling medium can be a gas, a liquid or a cooling roller (e.g. made of metal). The temperature for solidification by cooling is usually in the range from 20 to 100° C., preferably from 80 to 100° C. The cooling rate can be selected in a wide range, for example in the range from 3 to 200° C./sec.

The preformed and stretchable moulded part is stretched. Monoaxial stretching or preferably biaxial stretching can be used. In biaxial stretching, the preformed and stretchable product can be stretched simultaneously in the longitudinal and transverse directions, or it can be stretched sequentially in any order (i.e., first in the longitudinal direction and then in the transverse direction). In addition, stretching can be performed in a single step or in multiple steps.

Stretching is usually carried out in machine direction (“MD”) i.e. in longitudinal direction and preferably also transverse to machine direction (“TD”). The stretching ratio in machine direction is at least 1:2, preferably at least 1:3 and in particular 1:3 to 1:8. The stretching ratio transverse to machine direction is at least 1:3, preferably at least 1:5 and most preferably 1:5.5 to 1:12.

The stretching ratio in the area ratio is preferably at least 8-fold, preferably 10-fold to 100-fold and particularly preferably 15 to 70-fold. The stretching in MD and TD can also be carried out in several stages.

Following stretching, the stretched moulded part can be subjected to thermal fixing. This achieves particularly high dimensional stability at high temperatures. Thermal fixation can be carried out by conventional methods.

The shape of the domains is not fundamentally changed by the stretching process. However, the dimensions of the domains are reduced by the stretching process. Particularly in the case of two-dimensional (“biaxial”) stretching to form films, the dimensions are reduced in the thickness direction (perpendicular to the surface). Often, therefore, the domains in the stretched moulded parts can only be recognized to a certain extent with scanning electronic images due to the small dimensions, so that evaluation by means of image processing is no longer possible. The evaluation is therefore generally carried out on the undrawn mouldings.

According to the invention, coextruded multilayer mouldings can also be produced. These can be multilayer mouldings, for example multilayer films, in which several mouldings according to the invention are combined with one another. They may also be multilayer mouldings in which a moulded article according to the invention is combined with other moulded articles.

Preferably, polyolefin mouldings are single-layered or 2-, 3-, 4- or 5-layered, with multilayered polyolefin mouldings containing at least one of the polyolefin mouldings described above.

It was found that the formation of plate-like domains of cycloolefin polymer in the poly-(alpha-olefin) matrix leads to a property shift from blend properties to properties of a layered composite. Thus, the barrier properties of the polyolefin mouldings can be favorably influenced by the formation of plate-like domains. This can reduce the permeation of alcohols, water vapor or gases through the moulded article.

Mechanical properties, such as modulus of elasticity, creep resistance, dimensional stability or shrinkage, can also be favorably influenced by the formation of plate-like domains.

Furthermore, the formation of plate-like domains can also favorably influence electrical properties of polyolefin mouldings, such as resistance to creepage currents, dielectric strength, especially at elevated temperatures, or service life at elevated temperatures.

The polyolefin mouldings described here can be used in a variety of fields, preferably in applications where high dimensional stability and low shrinkage at elevated temperatures are required. Examples of applications include use as packaging films, in particular for packaging foodstuffs or pharmaceuticals, as containers, such as bottles, ampoules or vials, which can preferably be used in the medical field, as medical devices or parts thereof, such as syringe bodies or cannulae, as labels, or as components in the electrical and electronics field, in particular as dielectrics in capacitors. These applications are also within the scope of the present invention.

The invention also relates to a capacitor comprising at least one of the polyolefin films described above as dielectric.

The polyolefin films according to the invention preferably have dielectric strengths as known from polypropylene films, preferably an electrical dielectric strength of >500 V/μm, according to DIN EN 60243-2 measured under DC voltage at 23° C.

The polyolefin films according to the invention also preferably have a dielectric loss factor of less than or equal to 0.002, measured at a frequency in the range of 1 kHz and of 1 GHz at a temperature of 25° C.

The capacitors according to the invention can be all common types of capacitors. Examples include film capacitors. These are usually wound capacitors in which either only the metallized film (the metallized dielectric) or a non-metallized film (unmetallized dielectric) is wound together with a thin metal foil. A distinction is usually made between film capacitors, round-wound capacitors, flat-wound capacitors and ring capacitors. The standard manufacturing processes of the capacitors are known to the skilled person.

The invention is explained by way of example in the figures. No limitation is intended thereby.

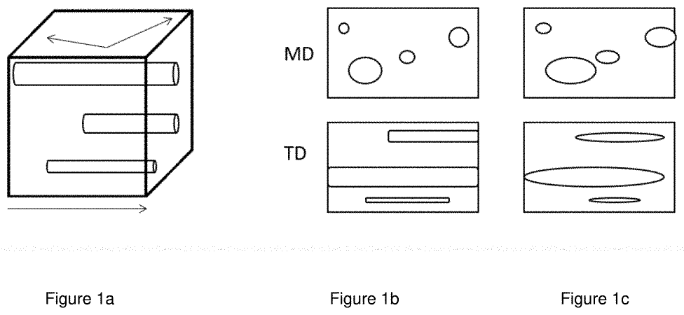

FIG. 1a schematically shows an unstretched polyolefin film not according to the invention made of 80 wt % polypropylene and 20 wt % cycloolefin copolymer (“COC”). The film thickness is 100 to 200 μm. Filamentary domains of COC, for example COC TOPAS 6013, have formed in a polypropylene matrix. The filaments run longitudinally to the machine direction.

FIG. 1b above shows a cross-section transverse to the machine direction. The round cross-sections of the filamentary COC domains are clearly visible.

FIG. 1b below shows a section in machine direction. The filamentary COC domains extending in the machine direction are clearly visible.

FIG. 1c shows at the top a section angled to the machine direction and also transverse to it. The direction of cut is indicated on the top of the cube in FIG. 1a. One can clearly see the ellipsoidal cross-sections of the filamentary COC domains.

FIG. 1c shows at the bottom a cut that is perpendicular to the cut of the upper part of this figure. This cut direction is also indicated on the top of the cube in FIG. 1a. One can clearly see the ellipsoidal cross-section of the filamentous COC domains extending in the machine direction.

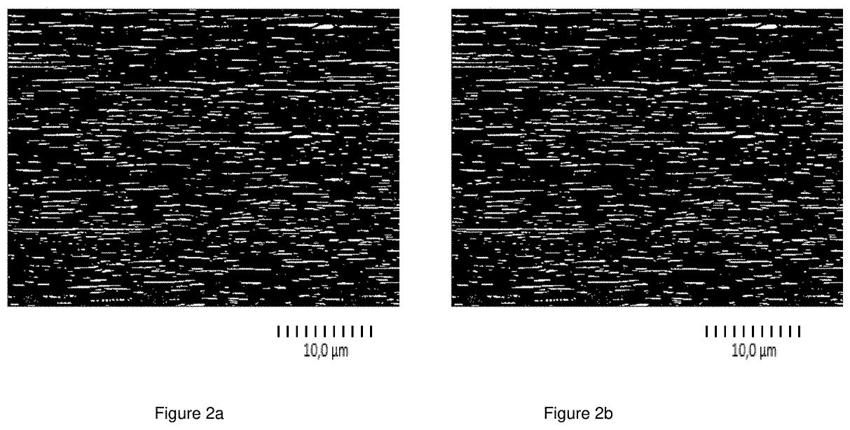

FIGS. 2a and 2b show scanning electron micrographs of an undrawn polyolefin film of polypropylene and COC according to the invention. The film thickness is 165 μm. Plate-like domains of COC have formed mainly in a polypropylene matrix. The plates run in the film plane and transverse to the film thickness.

FIG. 2a shows a section in machine direction. A predominant proportion of elongated phases of up to 5 μm in length and less than 0.5 μm in thickness can be seen running in the film plane. In addition, there are also a few round structures with dimensions of 0.1 to 0.3 μm. The phases elongated in the film plane are plate-like COC domains.

FIG. 2b shows a section transverse to the machine direction. Here, too, a predominant proportion of elongated phases of up to 10 μm in length and less than 0.5 μm in thickness can be seen running in the film plane. Round structures with dimensions of 0.1 to 0.3 μm are almost not visible. The phases elongated in the film plane are plate-like COC domains.

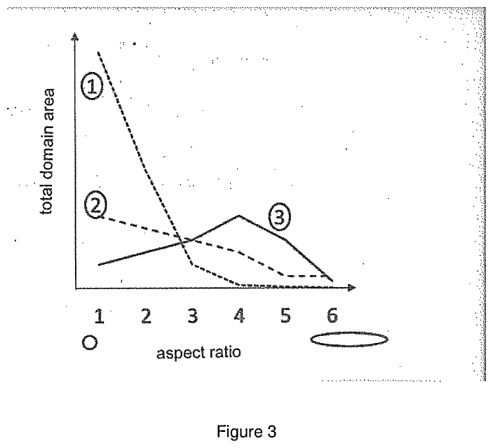

FIG. 3 schematically shows an evaluation of a frequency distribution of the quotient of lengths to thicknesses (“aspect ratio”) of plate-like domains in the machine direction from scanning electron micrographs of undrawn polyolefin films of polypropylene and COC. The plates of COC domains run in the film plane and transverse to the film thickness. The quotients of the domain lengths in the machine direction to the respective thicknesses are plotted on the abscissa (“aspect ratio”). The ordinate shows the shares of the individual domain shapes in the total area of the domains.

FIG. 3, curve 1, shows a film not according to the invention with a high proportion of filamentary domains with quotients between 1 and 3. Domains with quotients of 4 and higher are practically not found.

FIG. 3, curve 2, shows a film according to the invention with an increased proportion of plate-like domains with quotients between 4 and 6. Domains with quotients of 1 to 3 are present but account for less than 50% of the total number of all domains.

FIG. 3, curve 3, shows a film according to the invention with a high proportion of plate-like domains with quotients between 4 and 6. Domains with quotients of 1 to 3 are present only to a small extent.

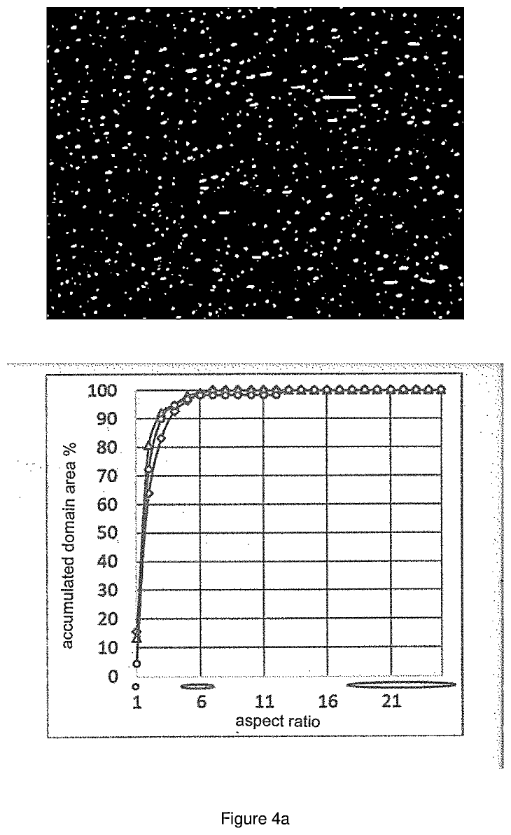

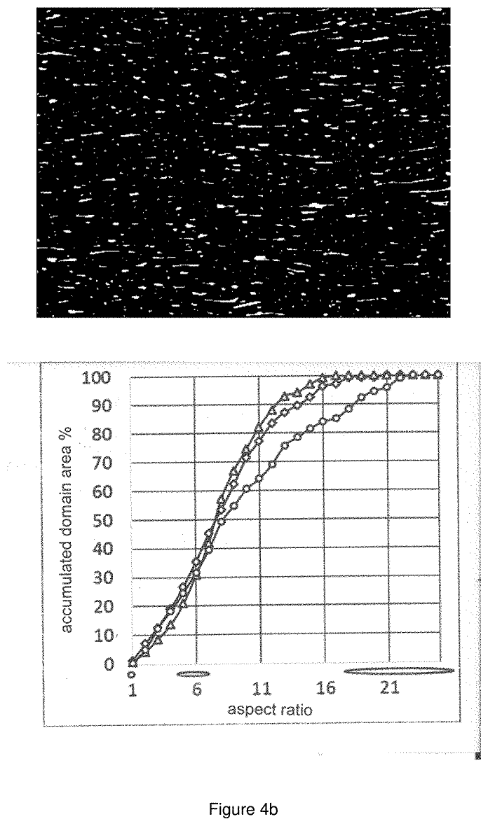

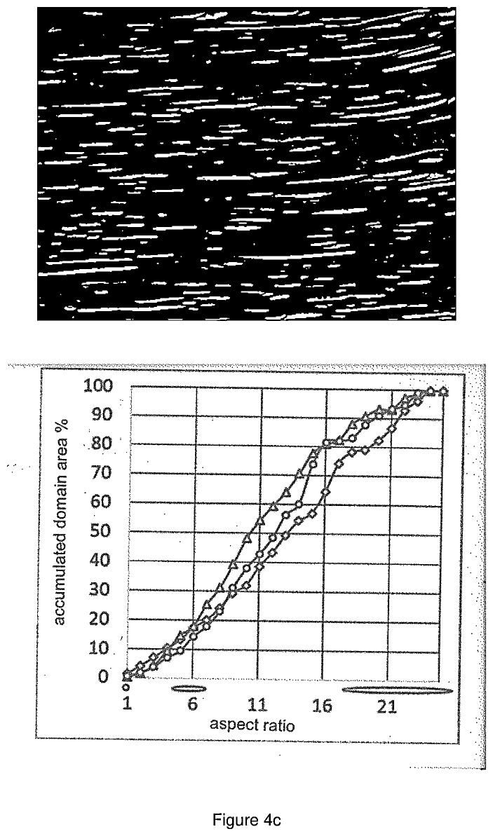

FIGS. 4a to 4c show scanning electron micrographs of unstretched polyolefin films of polypropylene and COC. In the lower halves of FIGS. 4a. 4b and 4c, the frequency distribution of the domain areas obtained by image analysis is plotted as a function of the aspect ratio of the domains.

FIG. 4a shows an example of a distribution of domains in a film of PP and COC not according to the invention. The figure shows a cross-section perpendicular to the machine direction (MD). Shown, in addition to an SEM image, are the frequency distribution of the domains and their aspect ratio (sums). The different curves are evaluations of different SEM images of the same film and thus show the reproducibility of the measurement. It can be seen that only 10% of the domain area (COC amount) is present in domains with an aspect ratio of 4 and greater (or vice versa—90% of the COC amount is in domains with smaller aspect ratio, i.e. the COC is present in the form of filaments in the PP).

FIG. 4b shows an example of a distribution of domains in a film of PP and COC according to the invention. The figure shows a cross-section perpendicular to the machine direction (MD). Shown, in addition to an SEM image, are the frequency distribution of the domains and their aspect ratio (sums). The different curves are evaluations of different SEM images of the same film and thus show the reproducibility of the evaluation. It can be seen that 50% of the domain area (COC amount) is present in domains with an aspect ratio of 4 and larger (or vice versa—only 50% of the COC amount is in domains with smaller aspect ratio).

FIG. 4c shows another example of a distribution of domains from a film of PP and COC according to the invention. The figure shows a cross-section parallel to the machine direction (MD). Shown, in addition to an SEM image, are the frequency distribution of the domains and their aspect ratio (sums). The different curves are based on evaluations of different SEM images of the same film and thus show the reproducibility of the evaluation. It can be seen that more than 90% of the domain area (COC amount) is present in domains with aspect ratio of 4 and larger (or vice versa—less than 10% of the COC amount is in domains with smaller aspect ratio).

1. A polyolefin composition comprising poly-(alpha-olefin) and 10 bis 45% by weight, referring to the total mass of the composition, of cycloolefin polymer having a glass transition temperature of at least 30° C., wherein the cycloolefin polymer forms domains in a matrix of poly-(alpha-olefin), which are shaped as plates.

2. The polyolefin composition according to claim 1, wherein the plates are shaped as ellipsoids.

3. The polyolefin composition according to claim 1, wherein the cycloolefin polymer domains form plates whose thickness is not more than 5% of the thickness of the polyolefin composition, a plurality of which are arranged one above the other as viewed in the direction of the thickness of the polyolefin composition and staggered perpendicularly thereto.

4. The polyolefin composition according to claim 1, wherein the composition comprises cycloolefin polymer domains having an aspect ratio of at least 4, the area fraction of these domains in the total area of the domains being at least 30%.

5. The polyolefin composition according to claim 1, wherein the composition is unstretched and wherein the domains have a quotient of the length in the flow direction of the melt to the length in the direction of the domain thickness of from 1 to 25, wherein the area fraction of the domains with a quotient of the length in the flow direction of the melt to the length in the direction of the domain thickness between 1 and less than 4 is less than 50% of the total area of the domains, and wherein the area fraction of the domains with a quotient of the length in the flow direction of the melt to the length in the direction of the domain thickness between 4 and 25 is more than 50% of the total area of the domains.

6. The polyolefin composition according to claim 1, wherein the composition is unstretched and wherein the domains have a quotient of the length transverse to the flow direction of the melt and perpendicular to the domain thickness—to the length in the direction of the domain thickness of from 1 to 25, wherein the area fraction of the domains having a quotient of the length transverse to the flow direction of the melt and perpendicular to the domain thickness to the length in the direction of the domain thickness between 1 and less than 4 is less than 40% of the total area of the domains, and wherein the area fraction of the domains having a quotient of the length transverse to the flow direction of the melt and perpendicular to the domain thickness to the length in the direction of the domain thickness between 4 and 25 is more than 60% of the total area of the domains.

7. The polyolefin composition according to claim 1, wherein the composition is unstretched and wherein the domains have a quotient of the length in the flow direction of the melt to the length transverse to the flow direction of the melt and perpendicular to the domain thickness of 1 to 6, wherein the area fraction of the domains with a quotient of the length in the flow direction of the melt to the length transverse to the flow direction of the melt and perpendicular to the domain thickness between 1 and 2 is less than 30% of the total area of the domains, and wherein the area fraction of the domains with a quotient of the length in the flow direction of the melt to the length transverse to the flow direction of the melt and perpendicular to the domain thickness—between 2 and 6 is more than 70% of the total area of the domains.

8. (canceled)

9. (canceled)

10. The polyolefin composition according to claim 1, wherein the cycloolefin polymer has a glass transition temperature between 120 and 170° C..

11. The polyolefin composition according to claim 1, wherein the composition comprises from 10 to 45% by weight of a cycloolefin polymer having a glass transition temperature between 120 and 170° C., and from 90 to 55% by weight of a semicrystalline alpha-olefin polymer having a crystallite melting temperature between 150 and 170° C., the glass transition temperature of the cycloolefin polymer being less than or equal to the crystallite melting temperature of the alpha-olefin polymer.

12. (canceled)

13. The polyolefin composition according to claim 1, wherein the poly-(alpha-olefin) is a partially crystalline propylene homopolymer or a copolymer obtained by copolymerizing propylene with an amount of less than or equal to 5% by weight of an alpha-olefin having two or having four to eight carbon atoms.

14. (canceled)

15. (canceled)

16. The polyolefin composition according to at least one of claims 1 to 15, wherein its total content of iron, cobalt, nickel, titanium, molybdenum, vanadium, chromium, copper and aluminum is less than 0.25 ppm.

17. A polyolefin moulded article produced from a polyolefin composition according to claim 1.

18. (canceled)

19. (canceled)

20. (canceled)

21. The polyolefin moulded body article according to claim 17, wherein the article is a film.

22. A method for manufacturing capacitors utilizing at least one polyolefin moulded body according to claim 17 as a dielectric.

23. Use of a polyolefin moulded body according to claim 17 as packaging film, containers, medical devices or parts thereof, labels, or components in the electrical and electronics sector.

24. (canceled)

25. A method for determining the shape of cycloolefin polymer domains in a polyolefin matrix comprising the steps of:
i) forming a moulded article from a polyolefin composition comprising poly-(alpha-olefin) and from 10 to 45 weight percent, based on the total weight of the composition, of of cycloolefin polymer having a glass transition temperature of at least 30° C.,
ii) cutting out sections from the moulded article in a predetermined direction,
iii) treating the sections with a solvent other than a solvent for the polyolefin matrix to remove the cycloolefin polymer from the sections, and
iv) examining the sections thus prepared with a microscope for the presence of cavities and for the shape thereof.

26. (canceled)

27. The process according to claim 25, wherein the solvent is an aliphatic or cycloaliphatic alcohol, preferably cyclohexane.

28. The process according to claim 25, wherein the examination in step (iv) is carried out with a scanning electron microscope.

29. The process according to claim 25, wherein the shape and size of the domains are determined by electronic image evaluation of microscopic images.

30. The polyolefin composition according to claim 1, wherein the plates are shaped as disks.
